(19) United States
(12) Patent Application Publication
(10) Pub. No.: US 2004/0207299 A1
(43) Pub. Date: Oct. 21, 2004

(54) Telecommunications cabinet

(76) Inventors: Frederick J. Diggle, Birmingham, AL (US); Jeffrey D. Witter, Birmingham, AL (US); Paul B. Rivers, Cullman, AL (US)

Correspondence Address: KIRKPATRICK & LOCKHART LLP, 535 SMITHFIELD STREET, PITTSBURGH, PA, 15222, US

(21) Appl. No.: 10/413,918

(22) Filed: Apr. 15, 2003

(51) Int. Cl. H02G 3/08

(52) U.S. Cl. 312/283; 174/52.1

(57) ABSTRACT

A telecommunications cabinet is disclosed. The telecommunications cabinet includes a housing and first, second and third doors. The housing is for enclosing telecommunications equipment and defines an access opening. The first door is connected to the housing via a first hinge and is moveable between a closed position and an open position. The second door is connected to the housing via a second hinge and is moveable between a closed position and an open position. The third door is connected to the housing via a third hinge and is moveable between a closed position and an open position. The third door overlaps the first and second doors when the first, second and third doors are in the closed position.

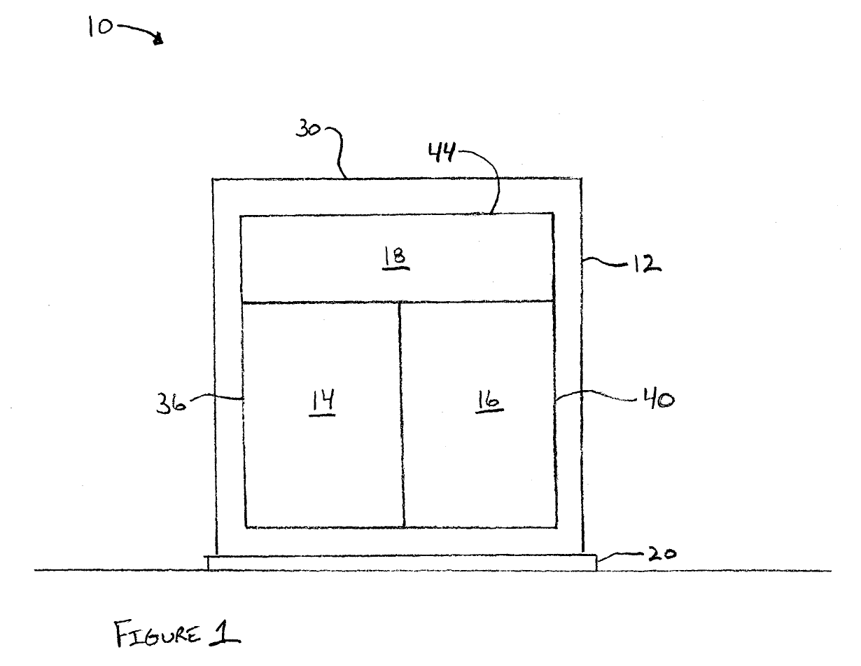

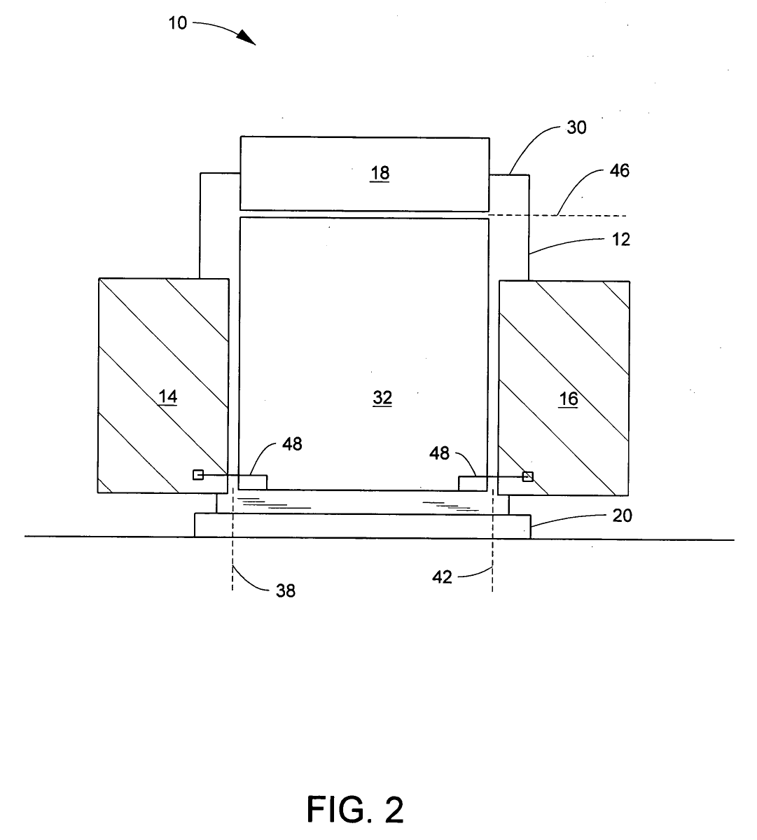

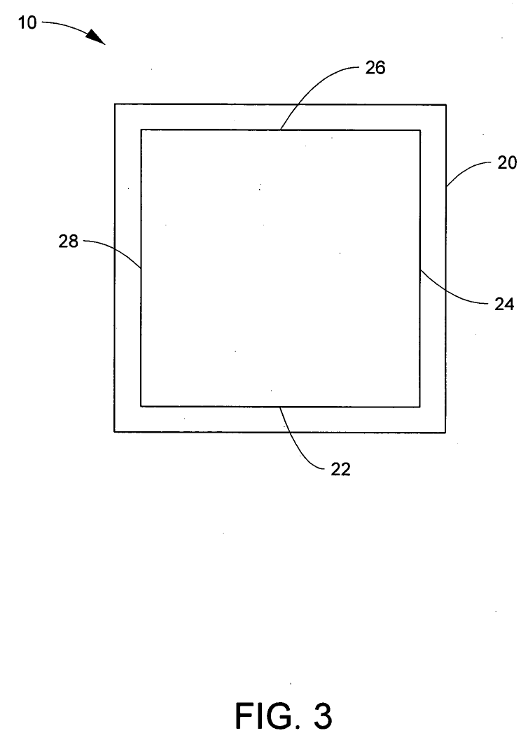

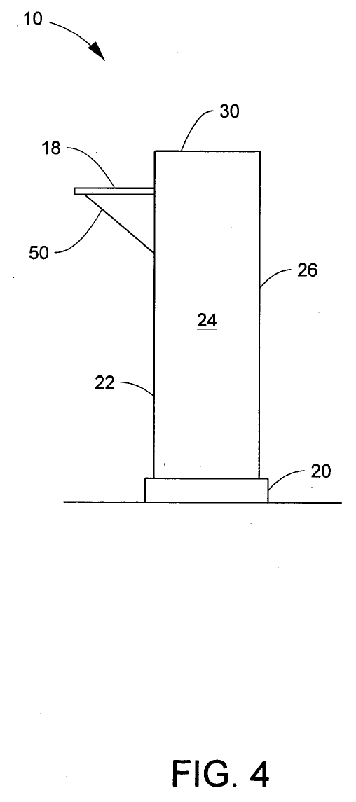

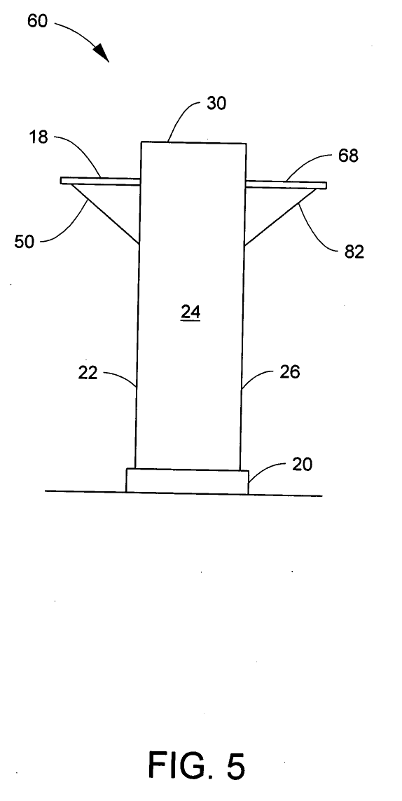

### CROSS-REFERENCE TO RELATED APPLICATIONS

The application for the new invention Prunus Plant Named ‘VSV-1’ is co-pending with three other plant patent applications entitled Prunus Plant Named ‘VVA-1’, Ser. No. 09/880,952, Prunus Plant Named ‘VSL-2’, Ser. No. 09/880,953, and Prunus Plant Named ‘LC-52’, Ser. No. 09/880,950, having the same filing date and inventor.

### BACKGROUND OF THE INVENTION

The present invention relates to the new and distinct cultivar known botanically as a hybrid of Prunus and referred to hereinafter as ‘VSV-1’. The new invention was bred by the inventor at the Breeding Station in Krymsk, Russia.

The breeding program at the Breeding Station was established in 1966 and funded by the government of the former Soviet Union for the purpose of producing new and improved Prunus cultivars that propagate well, have one central stem, few branches, and serve well as rootstock that is compatible with peach and plum.

In 1966 the inventor crossed the female parent Prunus incana (not patented) with the male parent Prunus tomentosa (not patented), producing an induced hybridization in a cultivated area of Krymsk, Russia. The resulting seedlings were observed and evaluated for ten years. In 1977 the inventor selected ‘VSV-1’ from these seedlings. The new cultivar originated as a single plant and is the result of a hybrid cross between the Prunus incana (not patented) and Prunus tomentosa (not patented).

The closest comparison plants are the parent plants. The characteristics that distinguish the new cultivar from Prunus incana are increased vigor, larger fruit, larger leaves and ease of propagation. The characteristics that distinguish the new cultivar from Prunus tomentosa are narrow leaves, small fruit, presence of stipules and strength of propagation. The distinguishing characteristics that make this cultivar unique from all other existing varieties of Prunus known to the inventor are vigor, the ability to propagate well by stool beds, resistance to drought, cold and heat and the ability to serve well as rootstock that is compatible with peach and plum.

‘VSV-1’ was first asexually propagated in 1977 by the inventor at the Breeding Station in Krymsk, Russia. The method used was softwood cuttings in vitro. The distinguishing traits have been determined stable and are reproduced true to type in successive generations.

### SUMMARY OF THE INVENTION

The following traits have been repeatedly observed and represent the distinguishing characteristics of the new cultivar. These traits in combination distinguish ‘VSV-1’ from all other existing cultivars of Prunus hybrid known to the inventor. ‘VSV-1’ has not been tested under all possible conditions and phenotypic differences may be observed with variations in environmental, climatic, and cultural conditions, however, without any variance in genotype.

1. ‘VSV-1’ propagates well by stool beds in addition to other methods.

2. ‘VSV-1’ serves well as rootstock that is compatible with peach and plum.

3. ‘VSV-1’ is resistant to drought, cold and heat.

4. ‘VSV-1’ is strong and vigorous.

5. ‘VSV-1’ is hardy to minus 15° Centigrade.

### BOTANICAL DESCRIPTION OF THE PLANT

The following is a detailed botanical description of the new rootstock variety Prunus hybrid ‘VSV-1’. Observations, measurements, values, and comparisons were collected in McMinnville, Oreg. from the inventor. The new variety was two (2) years old when described and was cultivated in a temperature variable environment. The foliage, flower and fruit exhibited by this cultivar are of no economic or commercial value, therefore comparisons and botanical descriptions of the foliage, fruit and flower are made for identification purposes only. Mature specimens, as well as bareroot specimens, were unavailable for photographing at the time this document was written. The color determinations are in accordance with the RHS Colour Chart of the Royal Horticultural Society, London, England except where general color terms of ordinary dictionary significance are used.

Botanical classification: Prunus incana×Prunus tomentosa.

Parentage: Prunus ‘VSV-1’ is an induced hybrid that resulted from crossing the following plants.

Female parent: Prunus incana (not patented).

Male parent: Prunus tomentosa (not patented).

Type: Deciduous tree.

Use: ‘VSV-1’ serves as rootstock that is compatible with peach and plum.

Soil: Light, sandy soil required.

Light: Full sunlight.

Fruit bearing: No fruit observed on plants up to 3 years of age.

Crop time: Requires 3 years from rooted cutting to achieve finished product size ready to ship bareroot.

Dimensions at crop time: 2.5 m. in height and 2 m. in width.

Vigor: 50-60% of standard. Prunus persica is used as the standard (peach seedling).

Habit: Dwarf and generally upright with some arching branches.

Hardiness: USDA Zone 4A.

Cold tolerance: Excellent.

Heat tolerance: Excellent.

Propagation: Can be propagated by hardwood, softwood cuttings, meristem cuttings in vitro, and stool beds (layering).

Rooting habit: Fine and fibrous initially. After 1 year roots become fleshy and thick.

Time to initiate roots: 5-6 months to develop roots at 22-25° Centigrade.

Disease and insect resistance: Normal resistance to disease and insects.

Trunk:

Trunk dimensions: At 3 years the trunk is 4 cm. in diameter and 20 cm. in height

(from soil level to first branch is 20 cm.).

Trunk bark surface: Glabrous surface.

Trunk bark color: 201A.

Lenticels: Present in small amount.

Lenticel shape: Linear to lens shaped.

Lenticel color: 198B.

Lenticel dimensions: Up to 4 mm. in length and 1 mm. in width.

Branches:

Branch surface: Pubescence on young emerging branches. Absent on other branches.

Branch color: 201B.

Internode length: 5-7 cm. between nodes.

Branching angle at emergence: 60-65° and straight.

Branching habit: Medium branching.

Pubescence: Present on young branches.

Pubescence color: 201C.

Lenticels (quantity): Present in small amounts on older branches and larger amount on young branches.

Lenticel shape: Linear to lens shape.

Lenticel color: 198B.

Lenticel dimensions: 2-3 mm. in length and 1 mm. in width.

Lenticel number: Approximately 9 per inch on rootstocks over 1 year old.

Leaves:

Arrangement: Alternate and whorled.

Leaf length: 4.5 cm. in length.

Leaf width: 2.5-3 cm. in width.

Leaf shape: Oblanceolate.

Leaf apex: Acuminate.

Leaf base: Cuneate.

Leaf color (adaxial surface): 132B.

Leaf color (abaxial surface): 132D.

Leaf surface (adaxial): Pubescent.

Leaf surface (abaxial): Pubescent.

Leaf margins: Crenulate.

Leaf division: Simple.

Petiole dimensions: 4-5 mm. in length and 1 mm. in diameter.

Petiole color: 131C.

Petiole surface: Pubescent.

Stipules: Present.

Stipule dimensions: 2-2.5 mm. in length and 1 mm. in width.

Stipule color: 132D.

Pubescence: Present on adaxial and abaxial surfaces.

Pubescence color: 201D.

Venation pattern: Pinnate.

Vein color (adaxial and abaxial surfaces): 131A.

Leaf texture: Wrinkled, and firm to leathery texture.

Leaf strength: Moderate strength.

Leaf appearance: Velvety on abaxial surface and dull on adaxial surface.

Fruit:

Maturity: 70 to 75 days to mature.

Dates of picking: Not a fruit crop. Fruit has no commercial value.

Production: Moderately fruit bearing.

Fruit form: Globose.

Stem dimensions: 4-5 mm. in length and 1 mm. in width.

Stem color: 143B.

Skin color: 45B.

Skin surface: Puberulent.

Lenticels: Absent.

Flesh color: 61D.

Flesh texture: Juicy.

Flavor: Sour cherry.

Aroma: None.

Seed number: One drupe.

Seed shape: Round.

Seed color: 164A.

Seed dimensions: 5-6 mm. in diameter and 5-6 mm. in length.

Storage: None has been determined.

Use: None has been determined.

Flower:

Arrangement: Solitary.

Flower shape: Rotate.

Bud dimensions: 3 mm. in width and 3 mm. in length.

Bud color: 56D.

Time of bloom: Flowers bloom at 1 year and last for 7-8 days.

Flower diameter: 2.5 cm. in diameter.

Flower depth (throat): 3 mm. in depth.

Bloom quantity: 50-60 flowers per branch.

Number of petals: Five petals in number.

Fused or unfused: Petals are unfused.

Petal shape: Obovate.

Petal margin: Entire and wavy.

Flower color fully opened (upper and lower surfaces): 155C.

Dimensions of peduncle: 3-4 mm. in length and up to 1 mm. in width.

Color of peduncle: 143C.

Surface of peduncle: Pubescent.

Calyx dimensions: 3 mm. in length and 2.5 mm. in width.

Calyx surface: Minimal pubescence.

Calyx color: 146B.

Number of sepals: Five sepals in number.

Natural flowering season: Spring.

Persistent or self-cleaning: Self-cleaning.

Fragrance: None.

Reproductive organs:

Stamen number: Polyandrous. 12-15 stamens and unequal lengths.

Stamen color: 155C.

Anther: Round with stamen attached at center of dorsal surface.

Anther color: 20B.

Anther dimensions: 1 mm. in length and 1 mm. in width.

Amount of pollen: Large amount.

Color of pollen: 20B.

Pistil: One in number.

Pistil color: 1C.

Pistil dimensions: 4 mm. in length and 1 mm. in width.

Style color: 9A.

Style dimensions: 1 mm. in length and 0.50 mm. in width.

Ovary dimensions: 2 mm. in length and 2 mm. in width.

Ovary color: 155C.

Ovary position: Superior.

I Claim:

1. A telecommunications cabinet, comprising:
a housing for enclosing telecommunication equipment, wherein the housing defines an access opening;
a first door connected to the housing via a first hinge, wherein the first door is moveable between a closed position and an open position;
a second door connected to the housing via a second hinge, wherein the second door is moveable between a closed position and an open position; and
a third door connected to the housing via a third hinge, wherein the third door is moveable between a closed position and an open position, and wherein the third door overlaps the first and second doors when the first, second and third doors are in the closed position, and wherein the access opening is partially uncovered when the third door is in the open position and the first and second doors are in the closed position.

2. The telecommunications cabinet of claim 1, wherein the access opening is covered by the first, second and third doors when the first, second and third doors are in the closed position.

3. The telecommunications cabinet of claim 1, wherein the access opening is uncovered when the first, second and third doors are in the open position.

4. The telecommunications cabinet of claim 1, wherein the second door overlaps the first door when the first and second doors are in the closed position.

5. The telecommunications cabinet of claim 1, wherein the first door is a left-hinged door, the second door is a right-hinged door, and the third door is a top-hinged door.

6. The telecommunications cabinet of claim 1, wherein the first hinge is oriented parallel to the second hinge.

7. The telecommunications cabinet of claim 1, wherein the third hinge is oriented perpendicular to the first and second hinges.

8. The telecommunications cabinet of claim 1, wherein the first, second and third doors are outswing doors.

9. The telecommunications cabinet of claim 1, further comprising first and second gas springs connected to the third door.

10. A dual-access telecommunications cabinet, comprising:
a housing for enclosing telecommunication equipment, wherein the housing defines first and second access openings;
a first door connected to the housing via a first hinge, wherein the first door is moveable between a closed position and an open position;
a second door connected to the housing via a second hinge, wherein the second door is moveable between a closed position and an open position;
a third door connected to the housing via a third hinge, wherein the third door is moveable between a closed position and an open position, and wherein the third door overlaps the first and second doors when the first, second and third doors are in the closed position, and wherein the first access opening is partially uncovered when the third door is in the open position and the first and second doors are in the closed position;
a fourth door connected to the housing via a fourth hinge, wherein the fourth door is moveable between a closed position and an open position;
a fifth door connected to the housing via a fifth hinge, wherein the fifth is moveable between a closed position and an open position; and
a sixth door connected to the housing via a sixth hinge, wherein the sixth door is moveable between a closed position and an open position, and wherein the sixth door overlaps the fourth and fifth doors when the fourth, fifth and sixth doors are in the closed position.

11. The telecommunications cabinet of claim 10, wherein the first access opening is opposite the second access opening.

12. The telecommunications cabinet of claim 10, wherein:
the first access opening is covered by the first, second and third doors when the first, second and third doors are in the closed position; and
the second access opening is covered by the fourth, fifth and sixth doors when the fourth, fifth and sixth doors are in the closed position.

13. The telecommunications cabinet of claim 10, wherein:
the first access opening is uncovered when the first, second and third doors are in the open position; and
the second access opening is uncovered when the fourth, fifth and sixth doors are in the open position.

14. The telecommunications cabinet of claim 10, wherein:
the second door overlaps the first door when the first and second doors are in the closed position; and
the fifth door overlaps the fourth door when the fourth and fifth doors are in the closed position.

15. The telecommunications cabinet of claim 10, wherein the first and fourth doors are left-hinged doors, the second and fifth doors are right-hinged doors, and the third and sixth doors are top-hinged doors.

16. The telecommunications cabinet of claim 10, wherein the first hinge is oriented parallel to the second, fourth and fifth hinges.

17. The telecommunications cabinet of claim 10, wherein the third hinge is oriented parallel to the sixth hinge.

18. The telecommunications cabinet of claim 10, wherein the third and sixth hinges are oriented perpendicular to the first, second, fourth and fifth hinges.

19. The telecommunications cabinet of claim 10, wherein the first, second, third, fourth, fifth and sixth doors are outswing doors.

20. The telecommunications cabinet of claim 10, further comprising:
first and second gas springs connected to the third door; and
third and fourth gas springs connected to the sixth door.
